(19) United States
(12) Patent Application Publication
(10) Pub. No.: US 2006/0080519 A1
(43) Pub. Date: Apr. 13, 2006

(54) Program-controlled unit

(75) Inventor: Werner Boning, Munchen (DE)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: Infineon Technologies AG

(21) Appl. No.: 11/243,118

(22) Filed: Oct. 4, 2005

Related U.S. Application Data
(63) Continuation of application No. PCT/DE04/00706, filed on Apr. 1, 2004.

(30) Foreign Application Priority Data
Apr. 4, 2003 (DE) 103 15 637.2

(51) Int. Cl. G06F 12/14

(52) U.S. Cl. 711/163

(57) ABSTRACT

A program-controlled unit has a memory for storing data and a memory protection device for protecting the memory from read- and/or write-access operations initiated by non-authorized personnel. The memory protection device signals a protection violation, when non-authorized personnel attempt a read-access of the memory when the read protection is active and/or when non-authorized personnel attempt a write access of the memory when the write protection is active and/or when non-authorized personnel attempt to deactivate or reconfigure the read- or write-access by accessing the memory protection device.

### CROSS-REFERENCE TO RELATED APPLICATIONS AND PRIORITY

This application is a continuation of co-pending International Application No. PCT/DE2004/000706 filed Apr. 1, 2004, which designates the United States of America, and claims priority to German application number DE 103 15 637.2 filed Apr. 4, 2003, the contents of which are hereby incorporated by reference in their entirety.

This application is also related to co-pending U.S. patent application entitled, “Program-Controlled Unit,” Ser. No. ______, filed Oct. 4, 2005, which is a continuation of PCT/DE2004/000705, filed Apr. 1, 2004; co-pending U.S. patent application entitled, “Program-Controlled Unit,” Ser. No. ______, filed Oct. 4, 2005, which is a continuation of PCT/DE2004/000707, filed on Apr. 1, 2004; and co-pending U.S. patent application entitled, “Program-Controlled Unit,” Ser. No. ______, filed Oct. 4, 2005, which is a continuation of PCT/DE2004/000704, filed on Apr. 1, 2004.

### TECHNICAL FIELD

The present invention relates to a program-controlled unit comprising a memory for storing data, and comprising a memory protection apparatus for protecting the memory against read and/or write accesses by persons not authorized for such access.

### BACKGROUND

Such a program-controlled unit is, for example, a microcontroller, a microprocessor, or a signal processor.

The basic construction of such a program-controlled unit is shown in FIG. 6.

The program-controlled unit shown in FIG. 6 is designated by the reference symbol PG. It contains a CPU CPU, a memory device M connected to the CPU, and peripheral units P1 to Pn connected to the CPU via a bus BUS.

The CPU executes a program which is stored in the memory device M or in another memory device (not shown in FIG. 6), where this other memory device may be a further internal memory device or an external memory device provided outside the program-controlled unit PG.

The memory device M serves for storing a program and/or the associated operands and/or other data.

The peripheral units P1 to Pn comprise, for example, a DMA controller, an A/D converter, a D/A converter, a timer, interfaces and controllers for the inputting and/or outputting of data, an on-chip debug support or OCDS module, etc.

It is not unusual for the developer of the program executed by the program-controlled unit to take an interest in preventing the program and/or the operands from being able to be read out and/or altered by persons not authorized to do this.

There may be two reasons for this. The first reason is the intention to prevent the program developer's competitors from copying the program, the operands or specific parts thereof and using these or the know-how contained therein in their own products. The second reason is the intention to prevent the program and/or the operands from being manipulated such that the device controlled by the program-controlled unit is no longer driven properly and is damaged.

There are already a variety of possibilities known for preventing programs and/or operands from being read out and altered by persons not authorized to do this.

By way of example, provision may be made for storing the data (programs and/or operands) to be protected in an internal memory of the program-controlled unit such as the memory device M, for example, and equipping the program-controlled unit with a memory protection apparatus that blocks read and/or write accesses to the internal memory that are instigated by persons not authorized for such access.

The known program-controlled units in which read and/or write accesses to the internal memory that are instigated by persons not authorized for such access are blocked either do not afford perfect read and/or write protection, and/or are complicated in terms of handling, and/or have a complicated construction and/or exhibit only limited possibilities for use.

### SUMMARY

The present invention is therefore based on the object of developing the program-controlled unit in accordance with the preamble of patent claim 1 in such a way that it affords a reliable read and/or write protection, has a simple construction, can be handled in a simple manner, and can be used universally.

This object can be achieved by a program-controlled unit comprising a memory for storing data, and comprising a memory protection apparatus for protecting the memory against read and/or write accesses by persons not authorized for such access, wherein the memory protection apparatus signals a protection violation at least if one of the following conditions is fulfilled:

a person not authorized to do so attempts to carry out a read access to the memory with read protection activated;

a person not authorized to do so attempts to carry out a write access to the memory with write protection activated;

a person not authorized to do so attempts to deactivate or reconfigure at least a read protection or a write protection by means of a corresponding access to the memory protection apparatus.

The signaling of the protection violation can be effected by means of a corresponding entry into a register of the program-controlled unit. The signaling of the protection violation can be effected by means of an interrupt request. The interrupt request can be a maskable interrupt request. The reaction of the program-controlled unit to the protection violation may comprise the fact that the access representing the protection violation is not executed. The reaction of the program-controlled unit to the protection violation may comprise the fact that the program-controlled unit is stopped. The reaction of the program-controlled unit to the protection violation may comprise the fact that the program-controlled unit is reset. The reaction of the program-controlled unit to the protection violation may comprise the fact that accesses by means of which the read protection and/or the write protection can be deactivated or reconfigured are no longer executed until the renewed start-up or until the next resetting of the program-controlled unit. After an attempt to alter configurations or settings relating to the read protection or the write protection using an incorrect password, a further attempt for altering the settings or configurations may not be possible until after the program-controlled unit has been reset or started up anew. After an attempt to temporarily cancel the read protection or the write protection using an incorrect password, a further attempt for temporarily canceling the read protection or the write protection may not be possible until after the program-controlled unit has been reset or started up anew.

The program-controlled unit according to the invention is distinguished by the fact that the memory protection apparatus signals a protection violation

if a person not authorized to do so attempts to carry out a read access to the memory with read protection activated; and/or

if a person not authorized to do so attempts to carry out a write access to the memory with write protection activated, and/or

if a person not authorized to do so attempts to deactivate or reconfigure the read protection and/or the write protection by means of a corresponding access to the memory protection apparatus.

As a result, other components of the program-controlled unit, in particular also the CPU of the program-controlled unit, may also experience attempted accesses by persons not authorized for such access, and may immediately implement measures which make it even more difficult for such access attempts to be successful. Consequently, the memory to be protected can be protected, in a simple manner, reliably against accesses by persons not authorized for such access.

### BRIEF DESCRIPTION OF THE DRAWINGS

The invention is explained in more detail below on the basis of exemplary embodiments with reference to the figures, in which

FIG. 1 shows the construction of a memory device of the program-controlled unit described below, which memory device can be protected against accesses by persons not authorized for such access,

FIG. 2 shows the arrangement of protection configuration bits in a first user configuration block of the memory device shown in FIG. 1,

FIG. 3 shows the arrangement of protection configuration bits in a second user configuration block of the memory device shown in FIG. 1,

FIG. 4 shows the arrangement of protection configuration bits in a third user configuration block of the memory device shown in FIG. 1,

FIG. 5 shows the construction of a configuration register of the memory device shown in FIG. 1, and

FIG. 6 shows the construction of a program-controlled unit.

### DETAILED DESCRIPTION

The program-controlled unit described below is a microcontroller. However, it shall already be pointed out at this juncture that the program-controlled unit could also be any arbitrarily other program-controlled unit such as, for example, a microprocessor or a signal processor.

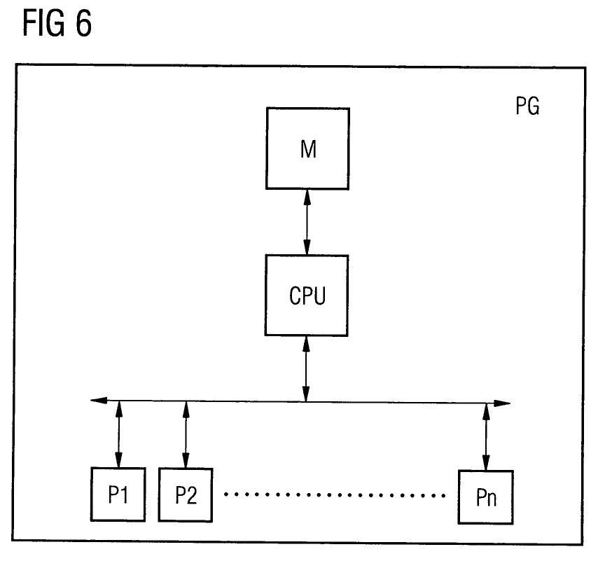

The microcontroller described has the same basic construction as the program-controlled unit shown in FIG. 6. However, it contains protection mechanisms which make it possible to prevent, in a particularly simple, flexible and reliable manner, data stored in the memory device M from being able to be read out and/or altered by persons not authorized to do this. Data are to be understood as both data representing instructions (instruction code) and “normal” data not representing any instruction code, such as operands, parameters, constants etc.

These protection mechanisms are part of the memory device M in the example under consideration.

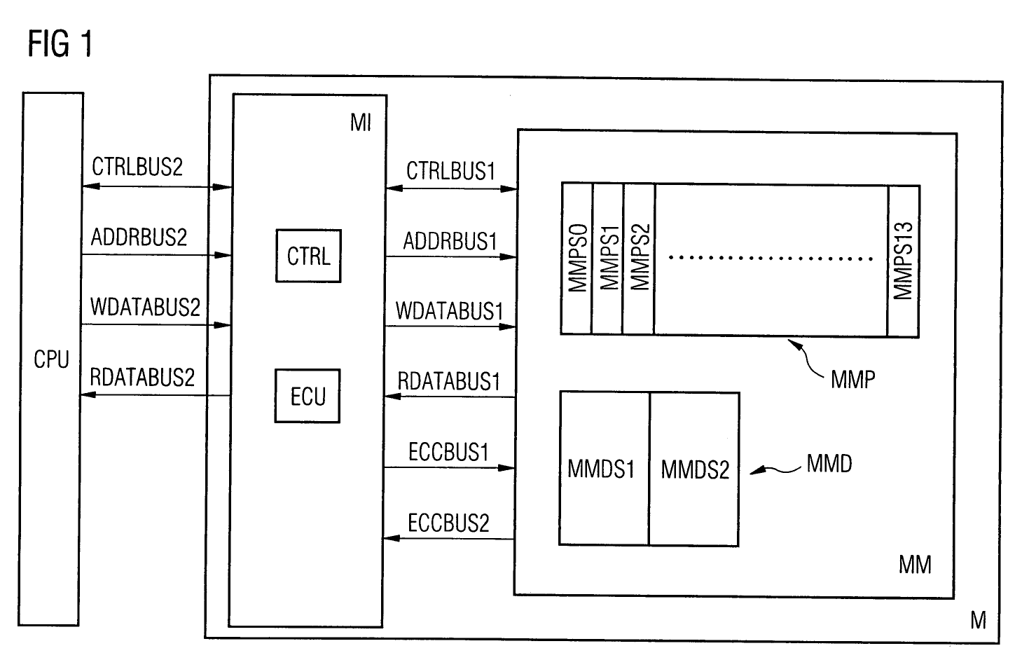

The construction of the memory device M of the microcontroller presented here is shown in FIG. 1.

The memory device M contains a memory module MM and an interface MI.

The memory module MM is the memory whose content is intended to be protected against read-out and/or alteration by a person not authorized to do this.

For the sake of completeness, it should already be noted at this juncture that when instructions and/or data originating from the memory module MM are buffer-stored in a cache, a scratchpad memory or some other buffer memory of the program-controlled unit, the content thereof also has to be protected against read-out by persons not authorized to do this.

In the example under consideration, the memory module MM contains a part MMP used as program memory, a part MMD used as data memory, and further components not shown in FIG. 1, such as, in particular, sense amplifiers, buffer memories, control devices, etc. For the sake of completeness, it shall already be pointed out at this juncture that the memory module MM could also be a memory used exclusively as program memory, or a memory used exclusively as data memory. Moreover, data (operands, constants, etc.) may also be stored in the program memory, and programs may also be stored in the data memory.

In the example under consideration, the memory module MM is formed by a flash memory. However, the memory module MM may also be another reprogrammable nonvolatile memory, for example an EEPROM, or a read only memory such as a ROM, for example, or a volatile memory such as a RAM, for example.

In the example under consideration, the program memory MMP is subdivided into 14 sectors MMPS0 to MMPS13, the sectors MMPS1 to MMPS13 being provided for storing programs, and the sector MMPS0 being provided for storing configuration data.

From the sectors MMPS1 to MMPS13 provided for storing programs, the sectors MMPS1 to MMPS8 each have a storage capacity of 16 kbytes, the sector MMPS9 has a storage capacity of 128 kbytes, the sector MMPS10 has a storage capacity of 256 kbytes, and the sectors MMPS11 to MMPS13 each have a storage capacity of 512 kbytes.

The configuration data stored in the sector MMPS0 serve for configuring the write protection and the read protection that prevent the data stored in the sectors MMPS1 to MMPS13 and in the data memory MMD from being read out and/or altered by persons not authorized to do this.

In the example under consideration, the data memory MMD has a storage capacity of 128 kbytes and is subdivided into 2 sectors MMDS1 and MMDS2 each comprising 64 kbytes.

For the sake of completeness, it shall be pointed out that both in the case of the program memory MMP and in the case of the data memory MMD, both the number of sectors and the size of the sectors may be arbitrarily much larger or smaller.

The memory module MM is addressed via the interface MI. That is to say that all accesses to the memory module MM are effected via the interface MI.

The interface MI contains a control device CTRL, an error correction device ECU, and also further components such as buffers, latches, registers, etc., not shown in FIG. 1.

The interface MI and the memory module MM are connected to one another via a control bus CTRLBUS1, an address bus ADDRBUS1, a write data bus WDATABUS1, a read data bus RDATABUS1, and error correction data buses ECCBUS1 and ECCBUS2.

The interface MI is connected to the CPU and further components of the microcontroller—which can access the memory device M—via a control bus CTRLBUS2, an address bus ADDRBUS2, a write data bus WDATABUS2, and a read data bus RDATABUS2.

In the example under consideration, the further components which can access the memory device M besides the CPU include a DMA controller, an OCDS module, and a peripheral control processor (PCP). However, it would also be conceivable for further and/or other microcontroller components to be able to access the memory device M.

If one of the devices which can access the memory device M would like to read out data from the memory device, to put it more precisely from the program memory MMP or from the data memory MMD, it communicates a read signal via the control bus CTRLBUS2, and via the address bus ADDRBUS2 the address at which the required data are stored. The control device CTRL of the interface MI firstly checks whether a permissible access is involved. An impermissible access is present in particular if a read protection is effective which is intended to prevent the read-out of the data requested by the read access from the memory device M. If the control device CTRL ascertains that an impermissible access to the memory device M is involved, it does not execute this access and, moreover, signals to the CPU and/or other microcontroller components that an impermissible access to the memory device M has been effected. Otherwise, that is to say if a permissible access is involved, the control device CTRL, by communicating corresponding control signals and addresses to the memory module MM, causes the data requested from the memory device M by the read access to be read out from the memory module MM and to be output to the interface MI. The control signals and addresses communicated to the memory module MM by the control device CTRL are transmitted via the control bus CTRLBUS1 and the address bus ADDRBUS1; the data output from the memory module MM are transmitted via the read data bus RDATABUS1.

In addition to the data transmitted via the read data bus RDATABUS1, the memory module MM also outputs error correction or ECC data assigned to said data. These data are transmitted via the ECCBUS2.

Afterward, the error correction device ECU, by evaluating the data received via the buses RDATABUS1 and ECCBUS2, checks whether the data transmitted via the read data bus RDATABUS1 are free of errors. If the data are not free of errors and a correctible error is involved, it corrects the latter. The way in which errors are detected and corrected using an ECC (error correction code) is known and need not be explained in any further detail.

The interface MI then outputs the data that have been output by the memory module MM and, if appropriate, corrected via the read data bus RDATABUS2 to the device from which the read access originated.

All other accesses to the memory device M, in particular also the accesses that cause the data stored in the memory device M to be erased, and the accesses that cause data to be written to the memory device M, are instigated or initiated by the transmission of command sequences based on the JEDEC standard, for example, to the memory device M. The transmission of a command sequence to the memory device M is ultimately nothing more than a write access to the memory device M. That is to say that the memory device M is fed a write signal via the control bus CTRLBUS2, an address via the address bus ADDRBUS2, and data via the write data bus WDATABUS2. A command sequence may comprise one or more successive write accesses to the memory device M.

The interface MI does not interpret write accesses to the memory device M as an access by means of which the data transmitted via the write data bus WDATABUS2 are to be written to the memory module MM. Instead, it interprets write accesses as commands. To put it more precisely, it determines on the basis of the addresses transmitted via the address bus ADDRBUS2 and on the basis of the data transmitted via the write data bus WDATABUS2 what action is to be executed in response.

In order to erase data in the memory module MM, a command sequence representing a command “Erase Sector” is transmitted to the memory device M. In the example under consideration, said command sequence comprises 6 write cycles, of which 5 cycles are pure failsafe cycles, that is to say cycles with fixed addresses and data, and a variable address and/or variable data are transmitted only in one cycle (the sixth cycle in the example under consideration). Such a command sequence may consist for example in the fact that
in a first cycle or in a first write access to the memory device, the address 5554 and the data AA,
in a second cycle or in a second write access to the memory device, the address AAA8 and the data 55,
in a third cycle or in a third write access to the memory device, the address 5554 and the data 80,
in a fourth cycle or in a fourth write access to the memory device, the address 5554 and the data AA,
in a fifth cycle or in a fifth write access to the memory device, the address AAA8 and the data 55, and
in a sixth cycle or in a sixth write access to the memory device, as address, the address of the sector to be erased and the data 30,
   are transmitted to the memory device. M.

For the sake of completeness, it should be noted that the addresses and data are specified above in the hexadecimal format, and that data stored in the memory module MM are erased in units of sectors, that is to say that it is only ever possible for a whole sector to be erased. Particularly if the memory module MM is not a flash memory, but rather is, for example, a RAM, a ROM, an EEPROM, etc., the erasure may also be effected in other units, for example page by page, word by word, etc.

The control device CTRL decodes the command sequence fed to the memory device M by write accesses. To put it more precisely, it determines the action that it is to take from the addresses and data fed to it by the write accesses.

If the memory device M is fed a command sequence representing the command “Erase Sector”, it recognizes that a specific sector in the memory module MM is intended to be erased. The control device CTRL then checks whether a permissible access to the memory device M is involved in this case. An impermissible access is present in particular if a write protection is effective for the sector to be erased. If the control device CTRL ascertains that an impermissible access to the memory device M is involved, it does not execute this access and, moreover, signals to the CPU and/or other microcontroller components that an impermissible access to the memory device M has been effected. Otherwise, that is to say if a permissible access is involved, the control device CTRL, by communicating corresponding control signals and addresses to the memory module MM, instigates the erasure of the sector specified in the “Erase Sector” command in the memory module MM.

In order to write data to the memory module MM, in the example under consideration, firstly a command sequence representing a command “Enter Page Mode” is transmitted to the memory device M. This command sequence may consist for example in the fact that, in a write access to the memory device M, the address 5554 and the data 50 are transmitted to the memory device M.

If the memory device M is fed a command sequence representing the command “Enter Page Mode”, it recognizes that it must change to the page mode. A page by page access to the memory module MM takes place in the page mode. In the example under consideration, a page comprises 256 bytes in the case of accesses to the program memory MMP, and 128 bytes in the case of accesses to the data memory MMD.

For the sake of completeness, it should be noted that the sizes of the pages may be of arbitrary magnitude, independently of one another. Furthermore, it should be noted that the “Enter Page Mode” command and also the further page commands that will be described in more detail below only have to be provided if the memory module MM is written to in page by page fashion. Particularly if the memory module is not formed by a flash memory, the writing to the memory module may also be effected in larger or smaller units, for example word by word.

The change to the page mode does not yet result in any writing of data to the memory module MM. This occurs only as a result of a “Write Page” command, which will be described in more detail later.

Before this command is executed, however, the data to be written to the memory module MM must first be transmitted to the memory device M. This is done by means of one or more “Load Page” commands.

A command sequence representing a “Load Page” command may consist for example in the fact that, in a write access to the memory device M, the address 5550 and, as data, 32 or 64 bits of the data which are intended to be written to the memory module MM are transmitted to the memory device M.

If the memory device M is fed a command sequence representing the command “Load Page”, the control device CTRL writes the data contained in the command sequence to a buffer memory of the interface MI, said buffer memory being formed by a register, for example. Furthermore, the control device CTRL, to put it more precisely the error correction device ECU thereof, generates for the data error correction or ECC data, using which, in the case where these data are later read out from the memory module MM, errors contained in the data read out can be detected and/or eliminated, and likewise stores these data in a buffer memory formed by a register, for example.

The memory device M is successively fed a sufficient number of command sequences representing “Load Page” until as many data as are encompassed by a page have been stored in the buffer memory.

The memory device M is then fed a command sequence representing a “write page” command. This command sequence may consist for example in the fact that
in a first cycle or in a first write access to the memory device, the address 5554 and the data AA,
in a second cycle or in a second write access to the memory device, the address AAA8 and the data 55,
in a third cycle or in a third write access to the memory device, the address 5554 and the data A0, and
in a fourth cycle or in a fourth write access to the memory device, as address, the address of the page to be written to within the memory module, and the data AA,
   are transmitted to the memory device.

At least now, that is to say after the reception of a “Write Page” command, but possibly even already after the reception of an “Enter Page Mode” command and/or after the reception of a “Load Page” command, the control device CTRL checks whether the relevant access is a permissible access to the memory device M. An impermissible access is present in particular if a write protection is effected that is intended to prevent alterations of the content of the memory area to be written to. If the control device CTRL ascertains that an impermissible access to the memory device M is involved, it does not execute this access and, moreover, signals to the CPU and/or other microcontroller components that an impermissible access to the memory device M has been effected. Otherwise, that is to say if a permissible access is involved, the control device CTRL, by communicating the corresponding control signal, address and data to the memory module MM, causes the data stored in the buffer memory to be written to the location specified in the “Write Page” command within the memory module.

Furthermore, the previously generated error correction or ECC data are transmitted from the control device CTRL to the memory module MM via the error correction data bus ECCBUS1 and are likewise stored in the memory module MM.

Only the sectors MMPS1 to MMPS13 of the program memory MMP and the sectors MMDS1 and MMDS2 of the data memory can be erased and written to by means of the commands described above. Other commands are required, at least in part, for erasing and writing to the sector MMPS0. These commands will be described in more detail later.

The read protection and write protection already mentioned repeatedly above are intended and are able to prevent data stored in the memory device M from being read out and/or altered by persons not authorized to do this.

The fact of whether and, if appropriate, to what extent a read protection and/or a write protection is effective depends, inter alia, on settings performed by the user of the microcontroller. However, it shall already be pointed out at this juncture that the fact of whether and to what extent a read protection and/or a write protection is effective also depends on other factors. This will be discussed in more detail later.

The settings that can be performed by the user are effected
by corresponding writing to user configuration blocks, designated hereinafter as UCBs,
by temporarily cancelling and reinstating the settings contained in the UCBs, and
by setting and resetting specific bits in control registers of the memory device M.

The aforementioned UCBs are part of the sector MMPS0 of the program memory MMP, and can only be written to, but not read from, by the user of the program-controlled unit. In the example under consideration, the sector MMPS0 of the program memory MMP contains three UCBs, which are designated hereinafter as UCB0, UCB1, and UCB2. Each UCB comprises four pages (page 0 to page 3), each of which comprises 256 bytes.

It shall already be pointed out at this juncture that more or fewer UCBs may also be provided, and that the number and the size of the pages that the UCBs comprise may be of arbitrary magnitude, independently of one another.

The UCB0 can be written to and erased by a first user of the program-controlled unit and contains, in the example under consideration,
read protection settings which enable the first user to prescribe whether a read protection is intended to be effective,
write protection settings which enable the first user to prescribe the parts of the memory module MM for which a write protection is intended to be effective,
a password that can be chosen by the first user, using which the first user can temporarily cancel the read protection defined by his read protection settings and/or write protection defined by his write protection settings, and
a predetermined confirmation code, by virtue of the writing of which to the UCB0 the first user confirms the validity of the data stored in the UCB0.

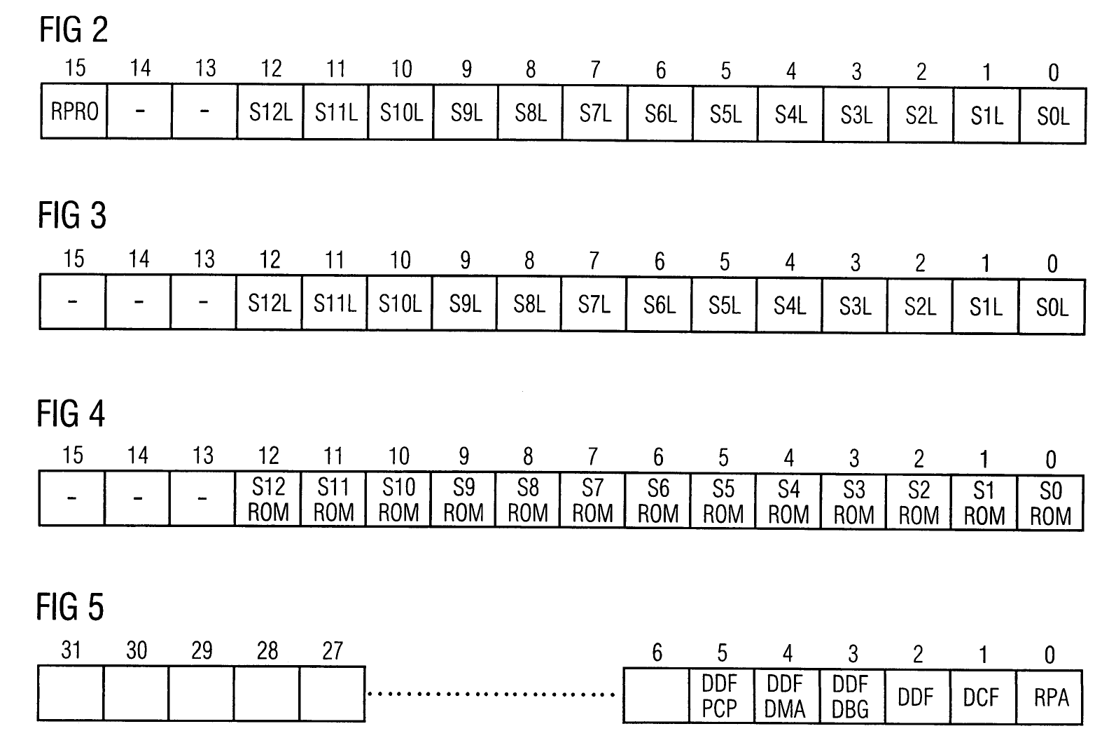

The read protection settings and the write protection settings comprise two bytes in the example under consideration. These bytes are designated as protection setting bytes hereinafter and are illustrated in FIG. 2.

The bits 0 to 12 of the protection setting bytes are write protection setting bits specifying those of the sectors MMPS1 to MMPS13 of the program memory for which a write protection is intended to be effective; the write protection setting bits are designated by the reference symbols S0L to S12L in FIG. 2. From the bits S0L to S12L, one bit is respectively assigned to one of the sectors MMPS1 to MMPS13. To put it more precisely, the bit S0L is assigned to the sector MMPS1, the bit S1L is assigned to the sector MMPS2, the bit S2L is assigned to the sector MMPS3, . . . , and the bit S12L is assigned to the sector MMPS13. The value of the individual bits S0L to S12L defines whether or not a write protection is intended to be effective for the assigned sector. If, by way of example, the bit S5L has the value 1, this means that a write protection is intended to be effective for the assigned sector MMPS6; if said bit has the value 0, this means that write protection is not intended to be effective for the assigned sector MMPS6.

The bit 15 of the protection setting bytes is a read protection setting bit specifying whether a read protection is intended to be effective for the memory module MM; the read protection setting bit is designated by the reference symbol RPRO in FIG. 2. If the bit RPRO has the value 1, this means that a read protection is intended to be effective; if the bit RPRO has the value 0, this means that read protection is not intended to be effective.

In the example under consideration, the password comprises 64 bits, but may also be arbitrarily longer or shorter.

In the example under consideration, the situation is such that the protection setting bytes and the password are part of the first page (page 0) of UCB0, the confirmation code is part of the third page (page 2) of UCB0, and the remaining pages (pages 1 and 3) of UCB0 are reserved for future uses.

The UCB1 can be written to and erased by a second user of the program-controlled unit and contains, in the example under consideration,
write protection settings that enable the second user to prescribe the areas of the memory module MM for which a write protection is intended to be effective,
a password that can be chosen by the second user, using which the second user can temporarily cancel the write protection defined by his write protection settings, and
a predetermined confirmation code, by virtue of the writing of which the second user confirms the validity of the data stored in the UCB1.

The write protection settings are contained in two protection setting bytes, as in the case of UCB0. These protection setting bytes are illustrated in FIG. 3.

The protection setting bytes of the UCB1 correspond to a very great extent to the protection setting bytes of the UCB0. The only difference is that a read protection setting bit RPRO is not provided in the protection setting bytes of the UCB1. This has the effect that the second user cannot determine whether or not a read protection is intended to be effective; this can only be done by the first user.

However, like the protection setting bytes of the UCB0, the protection setting bytes of the UCB1 contain write protection setting bits S0L to S12L, by means of which the second user can set those of the sectors MMPS1 to MMPS13 for which a write protection is intended to be effective.

In the example under consideration, the password comprises 64 bits, but may also be arbitrarily longer or shorter.

In the example under consideration, the situation is such that the protection setting bytes and the password are part of the first page (page 0) of UCB1, the confirmation code is part of the third page (page 2) of UCB1, and the remaining pages (pages 1 and 3) of UCB1 are reserved for future uses.

The UCB2 has some special features by comparison with the UCB0 and the UCB1 and will be described in more detail later.

By writing corresponding data to the protection setting bytes of the UCB0 and of the UCB1, the user or users of the microcontroller can set whether and to what extent a read protection and/or a write protection is intended to be effective.

If a read protection is intended to be effective, the first user of the microcontroller has to set the read protection setting bit RPRO of the protection setting bytes of the UCB0.

In the example under consideration, setting the read protection setting bit RPRO of the UCB0 has the effect of establishing that data are not intended to be able to be read out from the entire memory module MM. For the sake of completeness, it should be noted that it would be possible without any problems to provide setting possibilities in UCB0 that can have the effect of establishing that a read protection is intended to be effective only for specific areas of the memory module MM. This could be realized for example by providing additional read protection setting bits in the protection setting bytes of UCB0 and assigning the read protection setting bits then present to specific areas of the memory module MM in a similar manner to the write protection setting bits. The read protection setting bits could then be used to set the areas of the memory module MM for which a read protection is intended to be effective. Furthermore, it would also be possible, of course, for both the UCB0 and the UCB1 to contain one or more read protection setting bits. Both the first user and the second user could then set whether and, if appropriate, for what areas of the memory module MM a read protection is intended to be effective. It would of course also be possible for just the second user to be able to prescribe, by means of corresponding settings in UCB1, whether and, if appropriate, to what extent a read protection is intended to be effective.

If a write protection is intended to be effective, the first user of the microcontroller and/or the second user of the microcontroller must set one or more of the write protection setting bits S0L to S12L of the protection setting bytes of the UCB0 and of the UCB1, respectively.

In the example under consideration, the write protection setting bits S0L to S12L of UCB0 and UCB1 set the areas of the memory module MM, to put it more precisely the sectors of the memory module, for which a write protection is intended to be effective. A write protection is effective in each case only for those sectors which are assigned the set bits among the write protection setting bits S0L to S12L. If, from the write protection setting bits S0L to S12L of the UCB0 and of the UCB1, for example only the write protection setting bit S3L of the UCB0 and the write protection setting bit S5L of the UCB1 are set, this means that a write protection is intended to be effective only for the sectors MMPS4 and MMPS6.

The UCB2 already mentioned above can be written to by a third user of the program-controlled unit and contains, in the example under consideration,
write protection settings that enable the third user to prescribe what areas of the memory module MM are intended to behave like a ROM, and
a predetermined confirmation code, by virtue of the writing of which the third user confirms the validity of the data stored in the UCB2.

The write protection settings are contained in two protection setting bytes as in the case of the UCB0 and in the case of the UCB1. These protection setting bytes are illustrated in FIG. 4.

The bits 0 to 12 of the protection setting bytes are write protection setting bits specifying those of the sectors MMPS1 to MMPS13 of the program memory for which a write protection is intended to be effective; the write protection setting bits are designated by the reference symbols S0ROM to S12ROM in FIG. 4. From the bits S0ROM to S12ROM, one bit is respectively assigned to one of the sectors MMPS1 to MMPS13. To put it more precisely, the bit S0ROM is assigned to the sector MMPS1, the bit S1ROM is assigned to the sector MMPS2, the bit S2ROM is assigned to the sector MMPS3, . . . , and the bit S12ROM is assigned to the sector MMPS13. The value of the individual bits S0ROM to S12ROM defines whether or not a write protection is intended to be effective for the assigned sector. If, by way of example, the bit S5ROM has the value 1, this means that a write protection is intended to be effective for the assigned sector MMPS6; if this bit has the value 0, this means that write protection is not intended to be effective for the assigned sector MMPS6.

In this respect, the protection setting bytes of the UCB2 essentially correspond to the protection setting bytes of the UCB1. In contrast to UCB0 and UCB1, however, the UCB2 can no longer be erased and can no longer be rewritten to after the confirmation code has been written in. Furthermore—likewise in contrast to UCB0 and UCB1—the write protection defined by UCB2 cannot be temporarily deactivated. This has the effect that the write protection setting bits of the UCB2 prescribe whether and, if appropriate, what areas of the memory module MM behave like a memory that can never again be reprogrammed, that is to say like a ROM. After the confirmation code has been written to the UCB2, the latter behaves like a ROM which cannot be read at least by the user.

In the example under consideration, the situation is such that the protection setting bytes are part of the first page (page 0) of UCB2, the confirmation code is part of the third page (page 2) of UCB2, and the remaining pages (pages 1 and 3) of UCB2 are reserved for future uses.

The UCBs can be written to by the first or the second or the third user by communicating special command sequences to the memory device M.

The UCBs can also be erased again and written to anew—likewise by communicating special command sequences. However, they cannot be read from by the user of the program-controlled unit.

After the confirmation code has been written to the UCB2, however, the UCB2 can no longer be erased and no longer be written to.

In order to erase a UCB, it is necessary first of all, by means of the command “Disable Write Protection” that has already been mentioned above and will be described in more detail later, to cancel the write protection for the UCB to be erased, because although the sector MMPS0 containing the UCBs is not assigned a write protection setting bit in the UCBs, each UCB written to properly, that is to say including the correct confirmation code, is automatically read- and write-protected. It is only if the UCB to be erased has not yet been written to, or has not been written to properly that is to say has been written to without a valid confirmation code, that it is not necessary for the write protection to be cancelled.

For actually erasing a UCB, a command sequence representing a command “Erase UCB” is transmitted to the memory device M. This command sequence may consist for example in the fact that
in a first cycle or in a first write access to the memory device, the address 5554 and the data AA,
in a second cycle or in a second write access to the memory device, the address AAA8 and the data 55,
in a third cycle or in a third write access to the memory device, the address 5554 and the data 80,
in a fourth cycle or in a fourth write access to the memory device, the address 5554 and the data AA,
in a fifth cycle or in a fifth write access to the memory device, the address AAA8 and the data 55, and
in a sixth cycle or in a sixth write access to the memory device, as address, the address of the UCB to be erased and the data 40,
   are transmitted to the memory device M.

If the memory device M is fed a command sequence representing the command “Erase UCB”, it, to put it more precisely the control device CTRL thereof, recognizes that the UCB specified in the sixth cycle of the command sequence is intended to be erased. The control device CTRL then checks whether a permissible access is involved in this case. An impermissible access is present in particular if the UCB to be erased is write-protected. If the control device ascertains that an impermissible access is present, it does not execute the command and, moreover, signals to the CPU and/or other microcontroller components that an impermissible access to the memory device has been effected. Otherwise, that is to say if a permissible access is involved, the control device CTRL, by communicating corresponding control signals and addresses to the memory module MM, instigates the erasure of the UCB specified in the “Erase UCB” command in the sector MMPS0 of the memory module MM. Unlike in the case of the “Erase Sector” command described in the introduction, the “Erase UCB” command does not instigate the erasure of a complete sector of the memory module MM, but only of a specific UCB of the sector MMPS0.

In order to write data to a UCB, firstly an “Enter Page Mode” command, then one or more “Load Page” commands, and finally a “Write UC Page” command are transmitted to the memory device M.

Writing to a UCB is permissible only if the latter has as yet never been written to or has been erased previously. Whether this is the case is checked by the control device CTRL and can be identified for example from the fact that the UCB to be written to contains no or no valid confirmation code.

The command sequences representing the “Enter Page Mode” command and the “Load Page” command and also the reaction of the control device CTRL to these commands have already been described in the introduction.

The command sequence representing the “Write UC Page” command may consist for example in the fact that
in a first cycle or in a first write access to the memory device, the address 5554 and the data AA,
in a second cycle or in a second write access to the memory device, the address AAA8 and the data 55,
in a third cycle or in a third write access to the memory device, the address 5554 and the data 00, and
in a fourth cycle or in a fourth write access to the memory device, as address, the address of the page to be written to in the UCB to be written to, and the data 90,
   are transmitted to the memory device.

If the memory device M is fed a “Write UC Page” command, the control device CTRL checks whether the relevant access is a permissible access to the memory device M. An impermissible access is present in particular if the UCB to be written to already contains a valid confirmation code, that is to say is write-protected. If the control device CTRL ascertains that an impermissible access to the memory device M is involved, it does not execute this access and, moreover, signals to the CPU and/or other microcontroller components that an impermissible access to the memory device M has been effected. Otherwise, that is to say if a permissible access is involved, the control device CTRL, by communicating the corresponding control signals, addresses and data to the memory module MM, causes the data that have been fed to the memory device M by means of the “Load Page” command and buffer-stored to be written to that page of the UCB to be written to which is specified in the “Write UC Page” command.

The entries in UCB0, UCB1, and UCB2 only become effective if the respective confirmation code has been written to the UCBs. Alterations of the content of the UCBs that have been effected by erasing or writing to the UCBs manifest an effect, however, not until after the next resetting of the microcontroller.

The confirmation code should only be written to the respective UCB if it is certain that the information stored therein is correct. In particular, it should be certain that the password stored in the respective UCB is also the password that the user wanted to write to the UCB. This can be determined for example by means of the “Disable Write Protection” command that will be described in more detail later. The communication of a “Disable Write Protection” command to the memory device M results in an error message if the password contained in the command does not match the password stored in the UCB. If the user writing to the UCB communicates to the memory device M a “Disable Write Protection” command which contains the password just written to the UCB as password, then the fact of whether or not the password stored in the UCB is the password defined by the user can be identified from the occurrence or lack of appearance of said error message.

The UCB0 and the UCB1 can be written to and erased as often as desired by the first user or the second user of the microcontroller. Provision could also be made for permitting UCB0 and UCB1 to be erased and written to again only a specific number of times. By way of example, provision might be made for enabling the UCB0 and the UCB1 to be written to a maximum of five times.

The first user and the second user of the microcontroller have the possibility of temporarily deactivating the settings contained in UCB0 or in UCB1 by the transmission of corresponding commands, to put it more precisely by the transmission of command sequences representing these commands, to the memory device M. As a result, the first user can temporarily cancel the read and write protection that he set in UCB0 and the second user can temporarily cancel the write protection that he set in UCB1.

In the example under consideration, the aforementioned commands comprise a “Disable Write Protection” command, a “Disable Read Protection” command, and a “Resume Protection” command.

A command sequence representing a “Disable Write Protection” command may consist for example in the fact that
in a first cycle or in a first write access to the memory device, the address 5554 and the data AA,
in a second cycle or in a second write access to the memory device, the address AAA8 and the data 55,
in a third cycle or in a third write access to the memory device, the address 1111 and, as data, an identifier assigned to the user instigating the command,
in a fourth cycle or in a fourth write access to the memory device, the address 1112 and, as data, a first half of the password stored in the UCB assigned to the user specified in the third cycle,
in a fifth cycle or in a fifth write access to the memory device, the address 1112 and, as data, the second half of the password stored in the UCB assigned to the user specified in the third cycle, and
in a sixth cycle or in a sixth write access to the memory device, the address 3333 and the data 01,
   are transmitted to the memory device.

If the memory device M is fed a command sequence representing the “Disable Write Protection” command, it, to put it more precisely the control device CTRL thereof, checks first of all whether the identifier transmitted in the third cycle is the identifier assigned to the first user or the identifier assigned to the second user, and whether the password transmitted in the fourth cycle and in the fifth cycle is the password stored in the UCB assigned to the relevant user. The password must match the password stored in UCB0 if the identifier transmitted in the third cycle is the identifier assigned to the first user, must match the password stored in UCB1 if the identifier transmitted in the third cycle is the identifier assigned to the second user. If the check reveals that the stated conditions are not met, the control device CTRL assumes that the command fed to it is an impermissible access (an access by a person not authorized for such access) to the memory device M. In this case, the control device CTRL does not execute the command and, moreover, signals to the CPU and/or other microcontroller components that an impermissible access to the memory device M has been effected. Otherwise, the control device CTRL ensures that the write protection becomes ineffective to the extent to which it was defined by the user specified in the third cycle of the command sequence in the UCB assigned thereto.

In the example under consideration, the extent to which the write protection becomes ineffective additionally depends on the user from which the “Disable Write Protection” command originates. To put it more precisely, the situation in the example under consideration is such that the settings and commands of the first user have priority. That is to say that a “Disable Write Protection” command instigated by the second user can cancel the write protection only for those sectors for which the first user does not seek write protection. That is to say that if, by way of example, the write protection setting bits S0L and S1L are set in UCB0, and the write protection setting bits S0L and S2L are set in UCB1, then a “Disable Write Protection” command instigated by the second user cancels only the write protection for the sector MMPS3, but not also the write protection for the sector MMPS1, because the first user has also set a write protection for this sector. Conversely, however, the first user can cancel the write protection even for those sectors for which the second user has set a write protection. That is to say that if, by way of example, the write protection setting bits S0L and S1L are set in UCB0, and the write protection setting bits S0L and S2L are set in UCB1, then a “Disable Write Protection” command instigated by the first user cancels the write protection for the sectors MMPS1, MMPS2 and MMPS3.

It should be apparent that the opposite case is also possible, that is to say where the settings and commands of the second user have priority.

Furthermore, it is also possible for the first user and the second user to have equal authorization, and for no user to be able to cancel the write protection for sectors for which the respective other user has set a write protection.

It would also be conceivable to provide a setting possibility that makes it possible to set what effect a “Disable Write Protection” command of the respective users has. By way of example, provision might be made such that the respective users can set whether and, if appropriate, to what extent (for what sectors) the respective other user can cancel the write protection.

Independently of this, a “Disable Write Protection” command never results in the cancellation of the write protection for a sector which is intended to behave like a ROM in accordance with the settings in UCB2.

A command sequence representing a “Disable Read Protection” command may consist for example in the fact that
in a first cycle or in a first write access to the memory device, the address 5554 and the data AA,
in a second cycle or in a second write access to the memory device, the address AAA8 and the data 55,
in a third cycle or in a third write access to the memory device, the address 1111 and the data 00,
in a fourth cycle or in a fourth write access to the memory device, the address 1112 as data the first half of the password stored in UCB0,
in a fifth cycle or in a fifth write access to the memory device, the address 1112 as data the second half of the password stored in UCB0, and
in a sixth cycle or in a sixth write access to the memory device, the address 3333 and the data 02,
   are transmitted to the memory device.

If the memory device M is fed a command sequence representing the “Disable Read Protection” command, it, to put it more precisely the control device CTRL thereof, checks first of all whether the password transmitted in the fourth and fifth cycles matches the password stored in UCB0. If the check reveals that these conditions is not met, the control device CTRL assumes that the command fed to it is an impermissible access (an access by a person not authorized for such access) to the memory device M. In this case, the control device CTRL does not execute the command and, moreover, signals to the CPU and/or other microcontroller components that an impermissible access to the memory device M has been effected. Otherwise, the control device CTRL ensures that read protection is no longer effective.

A command sequence representing a “Resume Protection” command may consist, for example in the fact that, in a single cycle or in a single write access to the memory device, the address 5554 and the data BB are transmitted to the memory device M.

If the memory device M is fed a command sequence representing the “Resume Protection” command, the read protection and the write protection become effective again to the extent to which this is defined by the read and write protection setting bits of the UCB0 and of the UCB1.

The commands “Disable Read Protection”, “Disable Write Protection”, and “Resume Protection” manifest an effect in each case immediately, that is to say not for instance only after the next resetting of the microcontroller or some other later point in time.

The fact of whether and, if appropriate, to what extent a read protection and/or a write protection is effective also depends on the content of a memory configuration register. In the example under consideration, this memory configuration register is part of the control device CTRL of the memory device M. The construction of the memory configuration register is illustrated in FIG. 5.

As can be seen from FIG. 5, the memory configuration register is a 32-bit register, of which only the bits 0 to 5, however, are of interest in the present case.

Bit 0 is designated by the reference symbol RPA, bit 1 is designated by the reference symbol DCF, bit 2 is designated by the reference symbol DDF, bit 3 is designated by the reference symbol DDFDBG, bit 4 is designated by the reference symbol DDFDMA, and bit 5 is designated by the reference symbol DDFPCP.

The bit RPA specifies whether a read protection is intended to be effective. A read protection is effective and the bit RPA is set if the bit RPRO is set in UCB0, and the read protection is not temporarily cancelled by by the “Disable Read Protection” command.

The bits DCF and DDF define what type of read accesses to the memory module MM are intended to be permissible, and the bits DDFDBG, DDFDMA, and DDFPCP and/or further or other control bits define what microcontroller components which can access the memory device M can execute permissible read accesses to the memory device M. The bits DCF and DDF are evaluated, however, only if bit RPA is set. To put it more precisely, the situation is such
that it depends on the values of the bits RPA (read protection active) and DCF (disable code fetch) where the code fetches that is to say read accesses by the CPU of the microcontroller to data used as instruction code by the CPU are permissible; if the bit RPA is set and the bit DCF has the value 0, code fetches are permissible, otherwise they are not permissible.
that it depends on the values of the bits RPA (read protection active) and DDF (disable data fetch) where the data fetches, that is to say read accesses by the CPU of the microcontroller to data not used as instruction code are permissible; if the bit RPA is set and the bit DDF has the value 0, data fetches are permissible, otherwise they are not permissible.
that it depends on the value of the bit DDFDBG (disable data fetch from debug controller) whether a debug controller contained in the microcontroller, that is to say for example the OCDS module already mentioned in the introduction, is permitted to execute read access to the memory module MM (the program memory MMP and the data memory MMD); if the bit DDFDBG has the value 0, read accesses by the debug controller to the memory module MM are permissible, otherwise they are not permissible.
that it depends on the value of the bit DDFDMA (disable data fetch from DMA controller) whether a DMA controller contained in the microcontroller is permitted to execute read accesses to the memory module MM (the program memory MMP and the data memory MMD); if the bit DDFDBG has the value 0, read accesses by the DMA controller to the memory module MM are permissible, otherwise they are not permissible.
that it depends on the value of the bit DDFPCP (disable data fetch from PCP) whether a PCP (peripheral control processor) contained in the microcontroller is permitted to execute read accesses to the memory module MM (the program memory MMP and the data memory MMD); if the bit DDFDBG has the value 0, read accesses by the DMA controller to the memory module MM are permissible, otherwise they are not permissible.

It is also possible, of course, to provide even further configuration bits on whose value is respectively dependent the fact of whether a specific further component of the microcontroller or of the system containing the microcontroller is permitted to execute read accesses to the memory module MM (the program memory MMP and the data memory MMD). By way of example, it is possible to provide further configuration bits on whose value is dependent the fact of whether further processors of the microcontroller, or processors provided outside the microcontroller, are permitted to carry out read accesses to the memory module MM.

What microcontroller components accesses the memory module MM, and whether the access is a code fetch or a data fetch, can be determined on the basis of an identifier which the microcontroller component accessing the memory module MM communicates, in the event of an access to the memory module MM, together with the read request or the write request to the memory module MM or the memory device M.

The memory configuration register can be read from and written to both by means of hardware, in particular by means of the control device CTRL or some other microcontroller component, and by means of the user of the microcontroller.

In the example under consideration, the writing to the memory configuration register by means of the user of the microcontroller is effected by the communication of a command “Write Register” to the memory device M, to put it more precisely by the feeding in of a command sequences representing this command. However, it shall already be pointed out at this juncture that the memory configuration register could also be written to in a different manner, for example by means of a simple register access.

However, the user can only alter specific bits of the memory configuration register by means of the “Write Register” command, even this in some instances additionally being linked to specific conditions. In particular, it is not possible for the user to alter the bit RPA by means of the “Write Register” command. This bit can only be written to by means of the control device CTRL. Furthermore, it is not possible to alter the fetch control bits DCF and DDF by means of the “Write Register” command and if the bit RPA is set; before an alteration of the bits DCF and DDF, it is necessary, if appropriate, first to cancel the read protection by means of the “Disable Read Protection” command. However, under certain circumstances, it might prove to be advantageous if the read protection has to be cancelled only before the resetting of the bits DCF, DDF, and a setting of these bits can be carried out without cancelling the read protection. It is assumed below, however, that read protection is not permitted to be effective both when setting and when resetting the bits mentioned.

A command sequence representing a “Write Register” command may consist for example in the fact that
in a first cycle or in a first write access to the memory device, the address 5554 and the data CC, and,
in a second cycle or in a second write access to the memory device, as address, the address of the register to be written to and, as data, the data to be written to this register,
   are transmitted to the memory device.

If the memory device M is fed a command sequence representing the “Write Register” command, it, to put it more precisely the control device CTRL thereof, firstly checks whether a permissible access to the memory device M is involved in this case. An impermissible access is present for example if a read protection is effective and the bit DCF and/or the bit DDF is intended to be altered. If the control device CTRL ascertains that an impermissible access to the memory device M is involved, it does not execute this access and, moreover, signals to the CPU and/or other microcontroller components that an impermissible access to the memory device M has been effected. Otherwise, that is to say if a permissible access is involved, the control device CTRL causes the data transmitted in the second cycle of the command sequence to be written to the register specified in the second cycle of the command sequence.

For the sake of completeness, it should be noted that the memory device M additionally contains, besides the memory configuration register a flash status register, in which the current status of the memory module MM and also possible impermissible accesses to the memory device M are indicated. This register cannot be overwritten by the user. However, the status and error indications contained therein can be reset by means of the “Clear Status” command.

A command sequence representing a “Clear Status” command may consist for example in the fact that in a write access to the memory device, the address 5554 and the data DD are transmitted to the memory device.

For the sake of completeness, it should be noted that there additionally exists a “Read Register” command, by means of which the contents of specific registers of the memory device M can be read out. The registers that can be read by means of the “Read Register” command also include the memory configuration register and the flash status register.

Alterations of the bits DCF, DDF, DDFDBG, DDFDMA and DDFPCP manifest an effect in each case immediately, that is to say not for instance only after the next resetting of the microcontroller or some other later point in time.

As has been described above, the user of the microcontroller has a whole series of possibilities for configuring the read protection and the write protection in accordance with his wishes. When and to what extent the read protection and the write protection are effective are, however, also concomitantly determined by the memory device M, to put it more precisely by the control device CTRL thereof. This is explained in more detail below.

Directly after the microcontroller has been switched on or reset, the control device CTRL or some other microcontroller component checks whether a read protection is intended to be effective. This is the case if the read protection setting bit RPRO of the UCB0 is set and a valid confirmation code has been written to the UCB0.

If a read protection is intended to be effective, the control device CTRL or some other microcontroller component checks how the microcontroller is intended to behave after being switched on or reset. In the case of the microcontroller under consideration, three possibilities exist in this respect, namely,
1) that the microcontroller, after the start-up or the resetting, is intended to execute a program stored outside the memory device M, that is to say a program stored in an unprotected internal or external memory,
2) that the microcontroller, after the start-up or the resetting, is intended to execute a bootstrap loader fed to the microcontroller externally, and
3) that the microcontroller, after the start-up or the resetting, is intended to execute a program stored within the memory device M.

In the example under consideration, the way in which the microcontroller is intended to behave after the start-up or the resetting is prescribed to it by means of signals that are applied to specific input and/or output terminals of the microcontroller during the switching-on or the resetting of the microcontroller. By evaluating these signals, the microcontroller ascertains how it has to behave after being switched on or after being reset.

If it emerges in this case that the microcontroller, after the start-up or the resetting, is intended to execute a program stored outside the memory device M, the control device CTRL or some other microcontroller component ensures that the bits DCF and DDF of the memory configuration register are set, as a result of which, if a read protection is simultaneously desired, that is to say the bit RPA is set, neither read accesses to the program memory MMP nor read accesses to the data memory MMD are permitted. If the developer of the program stored outside the memory device M is not a person authorized to read from the memory device M, this person cannot cancel the read protection, because to do this the person would have to know the password stored in UCB0, but this should generally not be the case.

If the microcontroller, after the start-up or the resetting, is intended to execute a bootstrap loader fed to the microcontroller externally (e.g. via a serial interface of the microcontroller), the control device CTRL or some other microcontroller component ensures that the bits DCF and DDF are set and a read protection is thus effective while the program fed in is executed.

If the microcontroller, after the start-up or the resetting, is intended to execute a program stored within the memory device M, this is permitted and, furthermore, the control device CTRL or some other microcontroller component ensures that the bits DCF and DDF of the memory configuration register are reset, as a result of which both read accesses to the program memory MMP and read accesses to the data memory MMD are permitted.

As can be seen from the explanations above, it is only in the case where the microcontroller, after the start-up or the resetting, executes a program stored outside the memory device M that, by setting the bits DCF and DDF, care is taken to ensure that a read protection is effective. If the microcontroller, after the start-up or the resetting, executes a program stored within the memory device M, this is not necessary, because in this case the developer of the program stored in the memory device M can himself ensure that no read accesses by persons not authorized for such access are made to the memory device M: he may write the program stored in the memory device M such that no jumps to unprotected memories or memory areas are effected, or that when a jump to an unprotected memory or memory area is effected, the memory device M can no longer be accessed or only specific accesses can be made to the memory device M. This last may occur by virtue of the fact that the program stored in the memory device M contains instructions which ensure that the bits DCF and/or DDF of the memory configuration register are set before the execution of a jump to an unprotected memory or memory area. For the sake of completeness, it should be noted that with bit DCF not set, a return to the memory device M again is possible, whereas with bit DCF set, not even this is possible anymore. In order that a return to the memory device M can be effected, the read protection would firstly have to be cancelled by means of the “Disable Read Protection” command.

As a result, it is possible—partly automatically by means of the microcontroller and partly by means of a correspondingly written program—to reliably prevent the content of the memory device M from being read out by means of instructions not stored in the memory device M. Since, given corresponding configuration of the read/write protection, however, only specific persons are able to write to the memory device M, unauthorized persons have no chance of reading out or altering the content of the memory device M.

If the read protection setting bit RPRO of the UCB0 is set and a valid confirmation code has been written to the UCB0, the control device CTRL or some other microcontroller component preferably also immediately sets the bit DDFDBG of the memory configuration register, and if appropriate also the bits DDFDMA and/or DDFPCP of the memory configuration register. The bits mentioned may, however, also be set and reset by means of corresponding instructions in the executed program. This measure means that unauthorized persons also cannot access the memory device M via the debug controller and/or the DMA controller and/or the peripheral control processor.

Preferably, with read protection effective, a write protection is also automatically effective, to be precise for the entire memory device M. This makes it possible to prevent the situation where a person not authorized to do so writes a reading routine (for example a Trojan horse) to the memory device M, which might then read out the entire memory content and output it from the microcontroller.

The microcontroller furthermore ensures that after the start-up or the resetting of the microcontroller, a selective write protection, that is to say a write protection independent of the read protection, is effective to the extent defined in the UCBs.

This selective write protection can be temporarily completely or partially cancelled by the user by means of the “Disable Write Protection” and “Resume Protection” commands, to put it more precisely by means of program instructions that cause these commands to be communicated to the memory device M.

The write protection coupled with the read protection can be temporarily cancelled by means of the “Disable Read Protection” command.

As has already been mentioned repeatedly above, the control device CTRL of the CPU and/or some other microcontroller component signals a memory protection violation if an impermissible access is made to the memory device M. This may be effected for example by means of a corresponding entry into a status register, for example into the flash status register already mentioned above, and/or by means of an interrupt request. The way in which the CPU reacts to this preferably depends on the use of the microcontroller. The reactions may consist by way of example, but understandably not exclusively, in
ensuring that the program execution is ended and further instructions are no longer executed until the next start-up or until the next resetting of the microcontroller, or
ensuring that the impermissible access can be repeated with correct parameters, or
ensuring that, until the next start-up or or until the next resetting of the microcontroller, only specific accesses to the memory device M are permitted, for example only those accesses which have no influence on the extent of the read protection and/or of the write protection or are prerequisite for such accesses (that is to say a “Disable Read Protection” command, and/or a “Disable Write Protection” command, and/or a “Erase UCB” command, and/or a “Write UC Page” command is no longer executed).

The situation is preferably such that after an attempt to alter configurations or settings relating to the read protection or the write protection using an incorrect password, a further attempt to alter the settings or configurations is not possible until after the resetting or a renewed start-up of the program-controlled unit. At least after an attempt to temporarily cancel the read protection or the write protection using an incorrect password, a further attempt to temporarily cancel the read protection or the write protection should not be possible until after the resetting or a renewed start-up of the program-controlled unit.

It goes without saying that the microcontroller can also react differently in any desired way to an impermissible access to the memory device M. The reaction of the microcontroller can also be made dependent on the nature of the impermissible access. By way of example, it may be provided that the failed attempt to temporarily cancel the read protection (Disable Read Protection) is sanctioned by harder or more extensive measures than an impermissible read access to the data memory MMD.

As has already been explained, the UCB0 can be written to and erased by a first user of the microcontroller, the UCB1 can be written to and erased by a second user of the microcontroller, and the UCB2 can be written to by a third user. This proves to be advantageous because, in the example under consideration, up to three users can thereby protect their data against accesses by persons not authorized for such access, in a manner very largely independently of one another.

If the microcontroller described is part of a motor vehicle control unit, and the microcontroller executes a program whose instructions and/or operands originate partly from the manufacturer of the motor vehicle control unit, and partly from the manufacturer of the motor vehicle, then both the manufacturer of the motor vehicle control unit and the manufacturer of the motor vehicle can protect their program parts and/or operands against read-out and/or against alterations by persons not authorized to do this: the manufacturer of the motor vehicle control unit may be the first user of the microcontroller and configure the protection of its program parts and/or operands by correspondingly writing to the UCB0, and the manufacturer of the motor vehicle may be the second user of the microcontroller and configure the protection of its program parts and/or operands by correspondingly writing to the UCB1; furthermore, either the manufacturer of the motor vehicle control unit or the manufacturer of the motor vehicle may be the third user and configure the protection of its program parts and/or operands in addition by correspondingly writing to the UCB2. It goes without saying that the third user may also be a third person or a third company involved in the development of the program stored in the memory device M. Equally, it is of course also possible for a single person or a single company to be both the first user and the second user.

By providing further UCBs, it is also possible for even further users of the microcontroller to protect their data against accesses by persons not authorized for such access.

For the sake of completeness, it should be noted that the transmission of the command sequences described above to the memory device M and also the transmission of the command sequences for the configuration of the read protection and/or of the write protection are instigated by means of corresponding instructions in the program executed by the CPU.

The memory device M can ultimately be reliably protected in a very simple manner against accesses by persons not authorized for such access. Furthermore, the extent of the read protection and the extent of the write protection can be optimally adapted to the respective conditions independently of one another.

### LIST OF REFERENCE SYMBOLS

ADDRBUSx Address bus
BUS Bus
CPU CPU
CTRL Control device
CTRLBUSx Control bus
DCF Configuration bit
DDF Configuration bit
DDFDBG Configuration bit
DDFDMA Configuration bit
DDFPCP Configuration bit
ECCBUSx Error correction data bus
ECU Error correction device
M Memory device
MI Interface
MM Memory module
MMD Data memory
MMDSx Data memory sector
MMP Program memory
MMPSx Program memory sector
Px Peripheral unit
PG Program-controlled unit
RDATABUSx Read data bus
RPA Configuration bit
RPRO Read protection setting bit
SxL Write protection setting bit
SxROM Write protection setting bit
WDATABUSx Write data bus

What is claimed is:

1. A program-controlled unit comprising a memory for storing data, and comprising a memory protection apparatus for protecting the memory against read and/or write accesses by persons not authorized for such access,
wherein the memory protection apparatus signals a protection violation at least if one of the following conditions is fulfilled:
a person not authorized to do so attempts to carry out a read access to the memory with read protection activated;
a person not authorized to do so attempts to carry out a write access to the memory with write protection activated;
a person not authorized to do so attempts to deactivate or reconfigure at least a read protection or a write protection by means of a corresponding access to the memory protection apparatus.

2. A program-controlled unit according to claim 1, wherein the signaling of the protection violation is effected by means of a corresponding entry into a register of the program-controlled unit.

3. A program-controlled unit according to claim 1, wherein the signaling of the protection violation is effected by means of an interrupt request.

4. A program-controlled unit according to claim 3, wherein the interrupt request is a maskable interrupt request.

5. A program-controlled unit according to claim 1, wherein the reaction of the program-controlled unit to the protection violation includes that the access representing the protection violation is not executed.

6. A program-controlled unit according to claim 1, wherein the reaction of the program-controlled unit to the protection violation includes that the program-controlled unit is stopped.

7. A program-controlled unit according to claim 1, wherein the reaction of the program-controlled unit to the protection violation includes that the program-controlled unit is reset.

8. A program-controlled unit according to claim 1, wherein the reaction of the program-controlled unit to the protection violation includes that accesses by means of which a read protection and/or a write protection can be deactivated or reconfigured are no longer executed until the renewed start-up or until the next resetting of the program-controlled unit.

9. A program-controlled unit according to claim 1, wherein, after an attempt to alter configurations or settings relating to the read protection or the write protection using an incorrect password, a further attempt for altering the settings or configurations is not possible until after the program-controlled unit has been reset or started up anew.

10. A program-controlled unit according to claim 9, wherein, after an attempt to temporarily cancel the read protection or the write protection using an incorrect password, a further attempt for temporarily canceling the read protection or the write protection is not possible until after the program-controlled unit has been reset or started up anew.

11. A method of operating a program-controlled unit comprising a memory for storing data, and comprising a memory protection apparatus for protecting the memory against read and/or write accesses by persons not authorized for such access, the method comprising the step of:
generating a protection violation signal at least if one of the following conditions is fulfilled:
a person not authorized to do so attempts to carry out a read access to the memory with read protection activated;
a person not authorized to do so attempts to carry out a write access to the memory with write protection activated;
a person not authorized to do so attempts to deactivate or reconfigure at least a read protection or a write protection by means of a corresponding access to the memory protection apparatus.

12. A method according to claim 11, wherein the signaling of the protection violation is effected by a corresponding entry into a register.

13. A method according to claim 11, wherein the signaling of the protection violation is effected by an interrupt request.

14. A method according to claim 13, wherein the interrupt request is a maskable interrupt request.

15. A method according to claim 11, wherein the reaction of the program-controlled unit to the protection violation comprises the step of not executing the access representing the protection violation.

16. A method according to claim 11, wherein the reaction of the program-controlled unit to the protection violation comprises the step of stopping the program-controlled unit.

17. A method according to claim 11, wherein the reaction of the program-controlled unit to the protection violation comprises the step of resetting the program-controlled unit.

18. A method according to claim 11, wherein the reaction of the program-controlled unit to the protection violation comprises the step of no longer executing accesses by means of which a read protection and/or a write protection can be deactivated or reconfigured until the renewed start-up or until the next resetting of the program-controlled unit.

19. A method according to claim 11, wherein, after an attempt to alter configurations or settings relating to the read protection or the write protection using an incorrect password, a further attempt for altering the settings or configurations is not possible until after the program-controlled unit has been reset or started up anew.

20. A method according to claim 19, wherein, after an attempt to temporarily cancel the read protection or the write protection using an incorrect password, a further attempt for temporarily canceling the read protection or the write protection is not possible until after the program-controlled unit has been reset or started up anew.
